(19) United States
(12) Patent Application Publication
(10) Pub. No.: US 2026/0089215 A1
(43) Pub. Date: Mar. 26, 2026

(54) FPV Drone Detection System Utilizing Mesh Network of Sensors for Real-Time Tracking in Drone Activities

(71) Applicant: Christoper Tonn, Pensacola, FL (US)

(72) Inventor: Christoper Tonn, Pensacola, FL (US)

(21) Appl. No.: 18/897,007

(22) Filed: Sep. 26, 2024

(51) Int. Cl. H04L 67/12; G06V 10/70; H04W 84/18

(52) U.S. Cl. CPC H04L 67/12; G06V 10/70; H04W 84/18; G06V 2201/07

(57) ABSTRACT

The present invention discloses an FPV (First-Person View) drone detection system designed to identify and track drones using a mesh network of sensors. The system utilizes advanced technology to listen and identify drone video transmission signals, enabling real-time tracking of drone movements. The unique feature of this system lies in its utilization of a mesh network of sensors, allowing for seamless sharing of tracking data across the network. The invention is primarily intended for use in drone games and activities, such as drone racing, capture the flag, and other recreational drone activities.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The present invention relates to drones and is more particularly related to drone detection system utilizing mesh network of sensors for real-time tracking in drone activities.

### Description of the Related Art

Drones, also known as unmanned aerial vehicles (UAVs), have emerged as versatile tools with applications ranging from aerial photography and surveillance to package delivery and search and rescue operations. As the popularity and use of drones continue to grow, so does the need for effective systems for drone detection and tracking to ensure safety, security, and regulatory compliance in various settings.

These systems utilize a variety of technologies, including radar, acoustic sensors, radio frequency (RF) detectors, and optical cameras, to detect and track drones in real-time. By monitoring the airspace and identifying unauthorized or potentially hazardous drone activity, these systems play a crucial role in safeguarding critical infrastructure, public events, and sensitive locations.

Advancements in drone detection and tracking systems have been driven by the need to address evolving threats and challenges posed by drones, including privacy concerns, security risks, and the potential for malicious use. Modern systems incorporate sophisticated sensors, artificial intelligence (AI) algorithms, and data analytics capabilities to enhance detection accuracy, minimize false positives, and enable rapid response to drone incursions.

According to industry reports, the global market for drone detection and tracking systems is projected to reach USD 1.5 billion by 2025, driven by increasing investments in security infrastructure and regulatory initiatives aimed at mitigating drone-related risks. Governments, law enforcement agencies, critical infrastructure operators, and private enterprises are among the key stakeholders investing in drone detection and tracking solutions to protect assets, personnel, and the public.

There are multiple inventions that have been seen in prior art regarding drone technology. For instance, Device for piloting a drone bearing European patent EP2,3568,06B1 is issued to Parrot SA. The patent discloses an invention relates to a device (10) for piloting a drone (8), including a housing provided with a housing inclination detector (12) and a touchscreen (16), displaying a plurality of touch-sensitive areas (30, 32, 34, 36, 38, 40, 42). The drone is provided with a self-contained stabilization system for stationary flight when no other command is received from a user. The device includes a means, controlled by a tactile area (30) forming an activation/deactivation button, for alternately switching the drone piloting mode between (i) a mode of activating the self-contained stabilization system of the drone, in which the piloting commands sent to the drone are the result of transforming signals emitted by the touch-sensitive areas, and (ii) a mode of deactivating the self-contained stabilization system of the drone, in which the piloting commands sent to the drone are the result of transforming signals emitted by the inclination detector of the housing.

A Drone cleaning device bearing U.S. patent 2,017,0340,176A1 is issued to Hon Hai Precision Industry Co Ltd. The patent discloses a drone cleaning device for a building exterior comprises a main frame, a plurality of branch shafts set to the main frame, a plurality of power elements respectively set to the branch shafts, a plurality of adjustable supports set to the main frame, a plurality of rotatable elements respectively set to the adjustable supports and are configured to rotate relative to the adjustable supports, and a plurality of cleaning elements respectively set to the rotatable elements.

A Drone control method and device, ground control system and drone bearing Canadian patent 1,049,325,25A is issued to Chinese inventor. The patent discloses a drone control method comprising the steps that the current position and attitude of a drone are acquired; whether the drone enters a restricted area or a no-fly area is judged according to the current position and attitude of the drone; and when the drone enters the restricted area or the no-fly area, flight of the drone is controlled according to a flight control strategy corresponding to the area. The invention also discloses drone control device, the drone with the control device and a ground control system. The drone is enabled to automatically avoid the no-fly area so that flight efficiency and flight safety can be enhanced.

A Noise suppression device for a drone launch tube bearing European patent EP3,133,019B1 is issued to Aerovironment Inc. The patent discloses a 1.An unmanned aerial vehicle (UAV) launch tube (1010; 1310; 1520) which is closed at one end and comprises: a tethered sabot (700; 1050) configured to engage a UAV (1020; 1200) within a launcher volume defined by an inner wall, the tethered sabot dimensioned to provide a pressure seal at the inner wall and tethered to the inner wall.

Another patent Counter drone device, and method of using the same bearing US patent 2,019,008,6184A1 is issued to Stan William Sands. The patent discloses a counter drone device adapted to render propellers of drones inoperable. The counter drone device may be a weighted filament adapted to be projecting into the propeller of a drone so as to entangle/ensnare/wrap around propeller shaft and/or blades, rendering the drone inoperable.

A Device for launching and recovering a drone, and an associated aircraft bearing US patent 2,012,029,2430A1 is issued to Airbus Helicopters SAS. The patent discloses a device (10) for launching and recovering a drone (5), the device being suitable for being fastened to an aircraft. The device includes docking means (20) for a drone (5), the docking means (20) being provided with securing/releasing means (30) for the drone (5), said docking means (20) being secured to flared guide means (40) for guiding the drone (5) towards said docking means (20).

A Taking-off and landing system for drone, and operating method therefor bearing WIPO patent WO2,0160,890,66A1 is issued to a Korean inventor. The patent relates to a taking-off and landing system for a drone and, more specifically, to: a system in which a product is transported by a drone, in an unmanned way, to a device, possessed by a user, for enabling the drone to take-off and land; and an operating method therefor. The present invention comprises: a base (11) for providing a floor on which a drone (30) takes off and lands; a storage unit (13) for storing an ID of the base; and a first short range communication module (15) for wirelessly communicating with the drone accessing the base within a predetermined distance, wherein the first short range communication module transmits, to the drone, the ID of the base when the drone comes within a predetermined distance, and transmits a landing guide signal when a landing intention signal is received from the drone.

A Photographing device and method using drone to automatically track and photograph moving object earing WIPO patent WO2,017,0208,56A1 is issued to French & Chinese inventor. The patent discloses a device using a drone to automatically track and photograph a moving object, comprising: a drone flight platform, a load stabilization device, a photographing apparatus, and a mobile terminal, wherein the photographing apparatus is fixed to the drone flight platform via the load stabilization device and is configured to take an image of a moving object, and the mobile terminal is disposed on the moving object and can acquire location information of the moving object. According to location information of the drone flight platform and the moving object, a flightpath of the drone flight platform and a relative location of the photographing apparatus with respect to the drone flight platform are adjusted. Moreover, an orientation of the photographing apparatus is adjusted according to the image taken by the photographing apparatus, thereby enabling the photographing apparatus to track the moving object. The invention further relates to a method using a drone to automatically track and photograph a moving object, drone and control terminal.

A Drone equipped with spraying device bearing Japanese patent JP3,217,561U is issued to Japanese inventor. The patent discloses a drone is flying between the apples and various fruit trees and fruit trees vertically and horizontally, and sprayed pest control and pollenizer pollen provides drone mounted spray device for use in hand-pollination. A machine body 2, a plurality of rotor arms 3 extending in the horizontal radially from machine body center, a plurality of the electric motor 4 that is fixed to the distal end of the rotor arm, a plurality of propeller to be connected to the electric motor 5 comprising the in drone comprising a plurality of legs 6 that extend downwardly from the bottom surface of the machine body, injectable injection nozzle 11a of liquid spray material which is pumped by the pump in any direction, the spraying device comprising a 11b. Spraying device comprises a hose guide 14 which extends disposed in machine body and the horizontal lateral direction, attaching the hose guide is connected to the tip ejection nozzle connecting portion of the hose, the electric motor, the injection nozzle houses the rotary encoder comprising a spray unit 15a.

There are multiple solutions that have been presented in prior art. However, these solutions are limited and restricted to their conventional systems. The current invention is focused on presenting a drone detection system that utilizes a mesh network of sensors to listen and identify drone video transmission signals, enabling real-time tracking of drone movements. The system's ability to share tracking data across the network facilitates seamless coordination and monitoring of drone activities. The invention is specifically tailored for use in drone games and recreational activities, offering enhanced safety and security for participants.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary desirable object of the present invention is to provide a novel and improved form of a system to enhance safety and security during drone games and activities by providing reliable detection and tracking of FPV drones using a mesh network of sensors.

It is the objective of the system to prevent unauthorized drone incursions and ensure regulatory compliance by accurately identifying and monitoring drone video transmission signals in real-time.

It is the objective of the system to minimize disruptions and ensure a seamless experience for participants in drone games and activities by effectively tracking drones and facilitating timely interventions when necessary.

It is the objective of the system to enhance situational awareness and facilitate informed decision-making by providing real-time tracking data across the mesh network of sensors.

It is the objective of the system to optimize resource allocation and response efforts by enabling efficient sharing of tracking data among multiple sensors deployed in the vicinity.

It is the objective of the system to improve the overall safety and efficiency of drone-related events by offering a comprehensive solution for detecting and tracking drones.

It is the objective of the system to enhance the competitiveness and appeal of drone games and activities by providing accurate and reliable tracking capabilities to participants and spectators.

It is the objective of the system to support innovation and creativity in the development of new drone games and activities by offering advanced tracking technology as a foundational tool.

Thus, it is the objective to provide a new and improved assembly that fosters collaboration and community engagement by enabling the sharing of tracking data in real-time across our mesh network of sensors. Other aspects, advantages and novel features of the present invention will become apparent from the detailed description of the invention when considered in conjunction with the accompanying drawings.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Drones, also called unmanned aerial vehicles (UAVs), have no human pilot onboard, and instead are either controlled by a person on the ground or autonomously via a computer program. These stealth craft are becoming increasingly popular, not just for war and military purposes, but also for everything from wildlife and atmospheric research to disaster relief and sports photography. Drones are becoming the eyes and ears of scientists by surveying the ground for archaeological sites, signs of illegal hunting and crop damage, and even zipping inside hurricanes to study the wild storms.

The present invention is directed to The FPV (First-Person View) Drone Detection System thar represents a significant advancement in drone technology, particularly in the domain of drone detection and tracking. Unlike conventional systems that rely on single-point sensors or centralized monitoring stations, our system utilizes a sophisticated mesh network of sensors. These sensors are strategically deployed across the area of interest to provide comprehensive coverage and enable accurate detection and tracking of FPV drones. The mesh network architecture ensures redundancy and resilience, allowing the system to continue functioning even if individual sensors are compromised or fail.

As per further embodiments of system, the drone detection system is the capability to listen and identify drone video transmission signals. This involves the deployment of specialized sensors equipped with RF (Radio Frequency) receivers capable of detecting and decoding FPV video signals transmitted by drones. By analyzing the characteristics of these signals, such as frequency, modulation, and signal strength, our system can accurately identify the presence of drones within the monitored airspace. This capability is crucial for ensuring timely detection and tracking of drones, especially in environments where visual identification may be challenging or impractical.

As per further embodiments of system, the system utilizes a mesh network architecture for tracking drones. Unlike traditional systems that rely on centralized data processing and communication, our system leverages the distributed nature of mesh networks to facilitate real-time sharing of tracking data across multiple sensors. This allows for seamless coordination and collaboration among the sensors deployed in the network, enabling rapid response to drone incursions and ensuring effective monitoring of drone activities. Furthermore, the decentralized nature of the mesh network enhances system scalability and adaptability, making it suitable for deployment in diverse environments and applications.

As per further embodiments of system, in addition to detecting and tracking drones, our system offers advanced capabilities for data analysis and visualization. The tracking data collected by the sensors is processed and analyzed in real-time, allowing for the generation of actionable insights and situational awareness. Users can access a centralized control interface or dashboard to view the status of drone activity, track individual drones, and monitor airspace conditions. This capability enables stakeholders such as event organizers, security personnel, and regulatory authorities to make informed decisions and take appropriate actions in response to drone-related incidents.

As per further embodiments of system, the primary application of drone detection system is in drone games and recreational activities, including drone racing, capture the flag, and other competitive events. By providing accurate and reliable detection and tracking of FPV drones, our system enhances the safety, fairness, and overall experience of participants in these activities. Moreover, the real-time sharing of tracking data across the mesh network enables spectators and organizers to actively monitor and engage with the drone events, adding an extra layer of excitement and immersion.

As per further embodiments of system, the Drone Detection System represents a cutting-edge solution for detecting and tracking drones in various applications, with a focus on drone games and recreational activities. By leveraging a mesh network of sensors and advanced signal processing techniques, our system offers unparalleled capabilities for real-time detection, tracking, and data sharing. With its robust architecture, advanced features, and versatile applications, our drone detection system sets a new standard for safety, security, and enjoyment in the world of drone technology.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A drone detection system comprising a mesh network of sensors strategically deployed to listen and identify drone video transmission signals.

2. The drone detection system of claim 1, wherein the sensors are equipped with RF (Radio Frequency) receivers capable of detecting and decoding FPV video signals transmitted by drones.

3. The drone detection system of claim 1, wherein the mesh network architecture ensures redundancy and resilience, allowing the system to continue functioning even if individual sensors fail or are compromised.

4. The drone detection system of claim 1, comprising analyzing characteristics of drone video transmission signals to identify the presence of drones within a monitored airspace.

5. The drone detection system of claim 1, wherein further comprising processing and analyzing tracking data collected by the sensors in real-time to generate actionable insights and situational awareness.

6. The drone detection system of claim 1, wherein the mesh network of sensors allows for real-time sharing of tracking data across multiple sensors deployed in the network.

7. The drone detection system of claim 1, wherein the distributed nature of the mesh network enhances system scalability and adaptability, making it suitable for deployment in diverse environments and applications.

8. The drone detection system of claim 1, wherein it further comprises a centralized control interface or dashboard for accessing and visualizing tracking data, airspace conditions, and drone activity status.

9. The drone detection system of claim 1, wherein the system is specifically configured for use in drone games and recreational activities, including but not limited to drone racing and capture the flag.

10. The drone detection system of claim 1, wherein a method for enhancing safety and security in drone games and activities is provided by accurately detecting and tracking FPV drones in real-time.

11. The drone detection system of claim 1, wherein a method for facilitating seamless coordination and collaboration among participants and organizers of drone games and activities, comprising enabling real-time sharing of tracking data across the mesh network of sensors is ensured.

12. The drone detection system of claim 1, wherein a method for enhancing spectator engagement and immersion in drone games and activities, comprising providing access to a centralized control interface or dashboard for monitoring and visualizing drone activity status and airspace conditions.

13. The drone detection system of claim 1, wherein a method for promoting responsible and enjoyable drone use, comprising utilizing the drone detection to ensure compliance with safety regulations and mitigate risks associated with drone-related incidents.

14. The drone detection system of claim 1, wherein the system offers advanced features for data analysis, visualization, and reporting to enhance situational awareness and decision-making capabilities.

15. The drone detection system of claim 1, wherein the system sets a new standard for safety, security, and enjoyment in the world of drone technology by providing unparalleled capabilities for real-time detection, tracking, and data sharing.
